(19) United States
(12) Patent Application Publication
(10) Pub. No.: US 2023/0041416 A1
(43) Pub. Date: Feb. 9, 2023

(54) MECHANICALLY JOINING ADVANCED HIGH STRENGTH STEEL

(71) Applicant: Utica Enterprises, Inc., Troy, MI (US)

(72) Inventors: Mark A. SAVOY, Bloomfield Hills, MI (US); Phillip J. I. MORGAN, Royal Oak, MI (US)

(21) Appl. No.: 17/878,993

(22) Filed: Aug. 2, 2022

Related U.S. Application Data
(60) Provisional application No. 63/228,726, filed on Aug. 3, 2021.

(51) Int. Cl. B23K 26/21

(52) U.S. Cl. CPC B23K 26/21

(57) ABSTRACT

A method for mechanically joining steel applies a variable clamp force to a stack of sheet metal portions, which include at least one portion of advanced high strength steel (AHSS). The stack is heated to an optimal mechanical joining temperature to preserve the strength and material properties of the stack and to form a mechanical joint with the advanced high strength steel. A tool and system for performing the method, and a joint assembly formed by the method are provided.

### CROSS-REFERENCE TO RELATED APPLICATIONS

This application claims the benefit of U.S. provisional application Ser. No. 63/228,726 filed Aug. 3, 2021, the disclosure of which is hereby incorporated in its entirety by reference herein.

### TECHNICAL FIELD

Various embodiments relate to mechanically joining advanced high strength steel (AHSS).

### BACKGROUND

Savoy et al., U.S. Pat. No. 9,815,109 B2, which issued to Utica Enterprises, Inc., on Nov. 14, 2017, discloses an apparatus and method for mechanically joining advanced high strength steel.

### SUMMARY

According to an embodiment, a method applies a variable clamp force to a stack of sheet metal portions, which include at least one portion of advanced high strength steel. The stack is heated to an optimal mechanical joining temperature to preserve the strength and material properties of the stack and to form a mechanical joint with the advanced high strength steel.

According to another embodiment, a method clamps a stack of sheet metal portions, which include at least one portion of advanced high strength steel. The stack is heated to a temperature below a melting temperature of the stack to mechanically join the stack together. The temperature of the joining area, known as the heat affected zone (HAZ) portion of the stack, is controlled and monitored during the heating.

According to another embodiment, a tool assembly is provided with a pair of clamping surfaces to clamp a stack of sheet metal portions, which include at least one portion of advanced high strength steel. A pair of electrodes provide a pair of clamping surfaces to apply pressure and current through the stack to heat the stack so that a mechanical joint can be formed to join the stack together.

According to another embodiment, a system is provided with a tool assembly to clamp a stack of sheet metal portions, which include at least one portion of advanced high strength steel. An electrode arrangement is provided to heat the stack to a predetermined temperature to provide an optimal ductility in the stack to form a mechanical joint. A controller is in electrical communication with the tool assembly to monitor joining temperatures of a heat affected zone of the stack.

According to a further embodiment the tool assembly is provided with a laser assembly to heat the stack to an optimal temperature to form the mechanical joint.

According to another embodiment, an assembly is provided with at least one portion of advanced high strength steel with a protective coating. A metallic component is mechanically joined with at least one portion of advanced high strength steel.

### BRIEF DESCRIPTION OF THE DRAWINGS

FIG. 1 is a schematic view of a system for mechanically joining advanced high strength steel, according to an embodiment;

FIG. 2 is a schematic view of a system for mechanically joining advanced high strength steel, according to another embodiment;

FIG. 3 is a side elevation view of a tool assembly for mechanically joining advanced high strength steel, according to another embodiment, which may employ a C-shaped frame, and laser heating;

FIG. 4 is a side elevation view of a tool assembly for mechanically joining advanced high strength steel, according to another embodiment;

FIG. 5 is a partial section view of a tool assembly for mechanically joining advanced high strength steel, according to another embodiment, illustrated during a heating operation;

FIG. 6 is an enlarged schematic view of a zone affected by heat from the tool assembly of FIG. 5;

FIG. 7 is a resistance heating cycle graph of a joining operation according to an embodiment;

FIG. 8 is a common graph (also known as a banana chart) of typical tensile strength and ductility for various grades of sheet steel including advanced high strength steel grades;

FIG. 9 is an exploded perspective view of a tool assembly for mechanically joining advanced high strength steel, according to another embodiment;

FIG. 10 is a top plan view of a portion of the tool assembly of FIG. 9;

FIG. 11 is a section view the tool assembly taken along section line 11-11 in FIG. 10;

FIG. 12 is an exploded side elevation view of the tool assembly of FIG. 9;

FIG. 13 is a top plan view of a locking mechanism of the tool assembly of FIG. 9, illustrated in an unlocked condition;

FIG. 14 is an enlarged top plan view of a portion of the locking mechanism of FIG. 13;

FIG. 15 is a top plan view of the locking mechanism of FIG. 13, illustrated in a locked condition;

FIG. 16 is an enlarged top plan view of a portion of the locking mechanism of FIG. 15;

FIG. 17 is an exploded perspective view of the locking mechanism of FIG. 13, illustrated in the unlocked condition;

FIG. 18 is an exploded perspective view of the locking mechanism of FIG. 13, illustrated in the locked condition;

FIG. 19 is a graph of a heating operation according to an embodiment;

FIG. 20 is a graph of a heating operation according to another embodiment;

FIG. 21 is a graph of a heating operation according to another embodiment;

FIG. 22 is a perspective view of a tool assembly according to another embodiment;

FIG. 23 is a partial section view of the tool assembly of FIG. 22, illustrated in a retract position;

FIG. 24 is a partial section view of the tool assembly of FIG. 22, illustrated in a heating position;

FIG. 25 is a partial section view of the tool assembly of FIG. 22, illustrated in a joining position;

FIG. 26 is a partial view of an apparatus in preparation for clinching of a first sheet portion of advanced high strength steel and a second sheet portion of metal in preparation for mechanical joining;

FIG. 27 is an intermediate stage of the joining after initial downward movement of the punch to perform the clinching of the sheet portions to each other;

FIG. 28 shows the completion of the mechanical joint of the sheet portions to each other by the downward punch movement prior to upward movement of the punch for another cycle;

FIG. 29 is a view similar to FIG. 28 showing the sheet portions after mechanical joining by a clinch-rivet die and a clinch rivet moved by a rivet ram;

FIG. 30 is a view similar to FIG. 29 showing the sheet portions after mechanical joining of the sheet portions by a full punch rivet die and a full punch rivet moved by a rivet ram; and

FIG. 31 is a view similar to FIGS. 29 and 30 showing the sheet portions after mechanical joining to each other by a self-piercing rivet moved by a rivet ram and backed up by a self-piercing rivet die.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The terminology controller may be provided as one or more controllers or control modules for the various components and systems. The controller and control system may include any number of controllers, and may be integrated into a single controller, or have various modules. Some or all of the controllers may be connected by a controller area network (CAN) or other system. It is recognized that any controller, circuit, or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

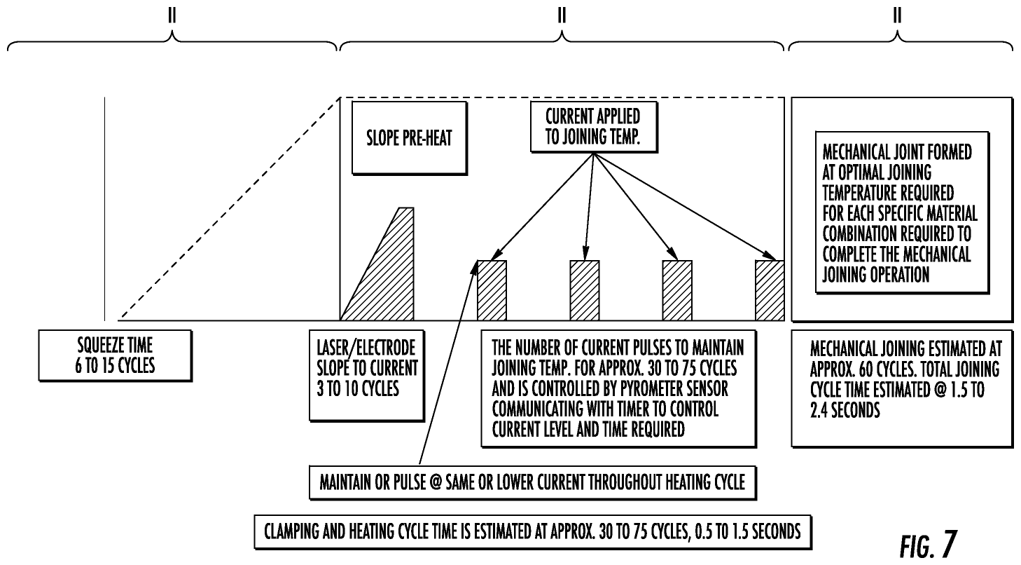

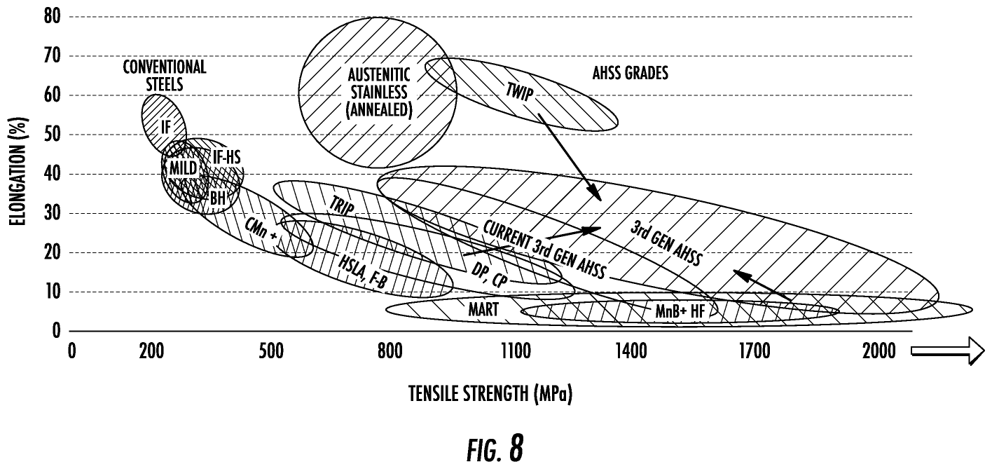

Recent advancements in steels have provided advanced high strength steel (AHSS) grades, with tensile strengths of 700 Megapascal (MPa) and beyond 2,000 Megapascal. Continued advancements to AHSS include high strength steel with increased ductility and energy absorbing capabilities. As illustrated in FIG. 8, AHSS is stronger and harder than conventional steel thereby permitting a stronger, light weight sheet steel material to provide improved occupant safety and improved fuel economy in comparison to conventional steels for vehicle applications. However, at tensile strengths of 980 Megapascal and greater, the hardness and ductility of this type of sheet steel becomes difficult to create a mechanical joint with conventional joining methods, systems, and tool assemblies that have traditionally been utilized for mechanically joining conventional steel stacks, such as vehicle assembly components.

AHSS has particular utility for use in vehicle body manufacturing such as with body-in-white (BIW) components, crash energy absorption, crash protection, occupant area components, and the like. AHSS provides high strength while using a thinner gauge and thus reduced weight construction that enhances vehicle energy efficiency while still having exceptional strength and manufacturability. However, such advanced high strength steels that are hard, are not sufficiently ductile to be capable for mechanical joining. For example, resistance spot welding of some AHSS may produce an undesirable resistance spot weld joint, which may result in joint failures, particularly hot stamped press hardened steel, such as MnB+HF steel.

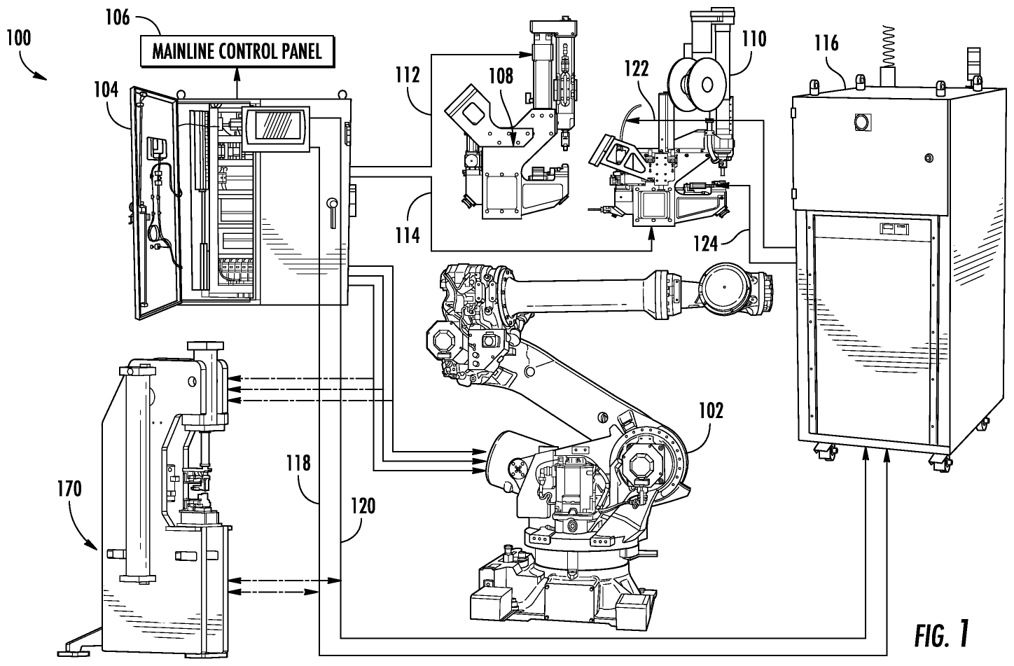

FIG. 1 illustrates a system 100 for mechanically joining AHSS according to an embodiment. In the depicted embodiment, the system 100 is a laser-assisted thermal joining system 100. The joining system 100 includes flexible automation, such as an industrial robot 102, in electrical communication with an integrator control panel or controller 104. The controller 104 may be in electrical communication with a mainline control panel 106.

The joining system 100 includes an end effector 108 for mechanical articulation by the industrial robot 102. The end effector 108 depicted is a class 1 laser-safe end of arm tool assembly 108, which is shown with a common clinch joining system for mechanically joining AHSS by heating with a laser and clinching or riveting a stack of material, which includes at least one AHSS sheet metal portion. The end effector 108 may be interchangeable with another end effector 110. The end effector 110 is a class 1 laser-safe end of arm tooling assembly 110, which is shown as a common rivet joining system 110 for mechanically joining AHSS by heating with the laser and then riveting the stack of material. Each of the end effectors 108, 110 is connected to the controller 104 with power and communication lines 112, 114 for control of an electrical actuator and a positioner of the end effector 108, 110. The end effectors 108, 110 may employ the teachings of Savoy et al., U.S. Pat. No. 9,815,109 B2, which issued to Utica Enterprises, Inc., on Nov. 14, 2017, and is incorporated in its entirety by reference herein. Other mechanical joining processes are contemplated for use with the laser heated system 100.

The joining system 100 includes an integrated laser system 116 with a closed loop chiller. The laser system 116 is connected to the control panel 104 by a power supply line 118 and a communication line 120. The laser system 116 provides a laser beam fiber feed cable 122 and cooling circuits 124 to each tool 108, 110. The controller 104 is in communication with the robot 102, the end effectors 108, 110, and the laser system 116 so that the robot presents the end effector 108, 110 to the stack of sheet metal portions. The laser system 116 heats the stack with the laser-safe end effector 108, 110. Then, the end effector 108, 110 mechanically joins the stack to create the mechanical interlock. The joining system 100 may employ the teachings of Savoy et al., U.S. Pat. No. 9,815,109 B2. Alternatively, a pedestal fixture 170 may be in communication with the control panel 104 and the integrated laser system 116 for performing the heating and mechanical joining operation without utilizing the industrial robot 102.

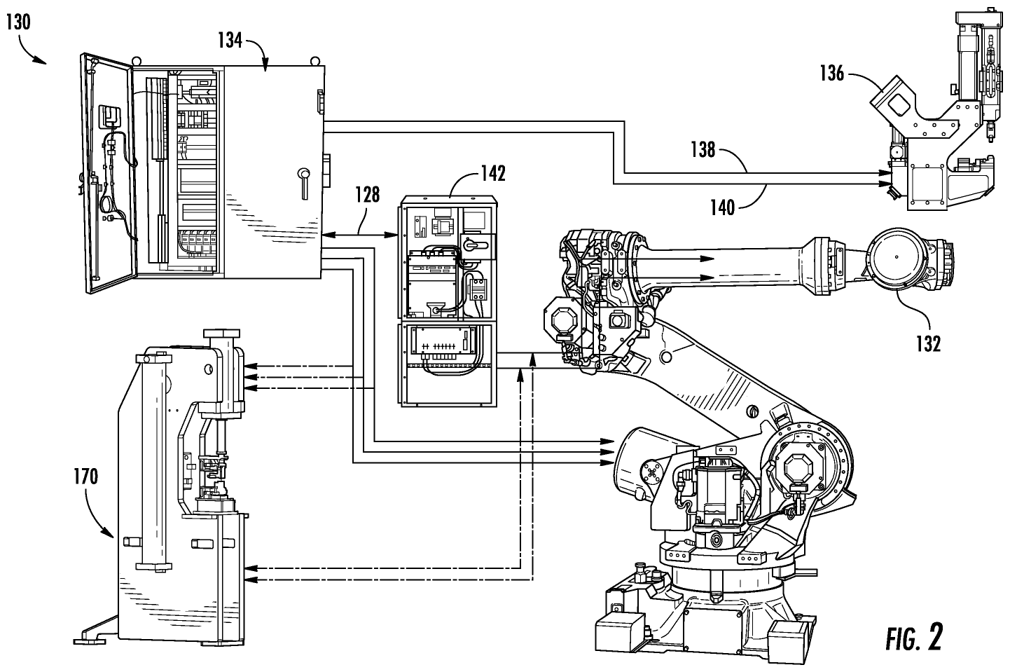

FIG. 2 illustrates a system 130 for mechanically joining AHSS according to another embodiment. In the depicted embodiment, the system 130 is a resistance thermal joining system 130. The joining system 130 includes an industrial robot 132, in electrical communication with an integrated control and power distribution panel or controller 134. The controller 134 may be in electrical communication with a mainline control panel 106, as in the prior embodiment.

The joining system 130 includes an end effector 136 for mechanical articulation by the industrial robot 132. The end effector 136 depicted is a thermal joining end of arm tool assembly 136, which is shown with a common clinch joining system for mechanically joining a stack of AHSS by heating with an electrode assembly and mechanically joining a stack of material, which includes at least one AHSS sheet metal portion. The end effector 136 may also be a rivet joining end of arm tool assembly 136. The end effector 136 may be interchangeable with other end effectors. The end effector 136 is connected to the controller 134 with power and communication lines 138, 140 for control of the electrical actuator and the positioner of the end effector 136. The controller 134 is in communication with the timer 142 at communication line 128.

The joining system 130 includes a timer 142 in electrical communication with an electrode assembly on the end effector 136. The controller 134 is in communication with the robot 132, the end effector 136, and the timer 142 so that the robot 132 presents the end effector 136 to the stack of sheet metal portions. The timer 142 directs current to the heat affected zone (HAZ) joining area to heat the stack at the end effector 136, while monitoring temperature of the HAZ in the stack. Then, the end effector 136 mechanically joins the stack. The joining system 130 may employ the teachings of Savoy et al., U.S. Pat. No. 9,815,109 B2. Alternatively, a pedestal fixture 170 may be in communication with the controller 134 and the timer 142 for performing the heating and mechanical joining operation without utilizing the industrial robot 132.

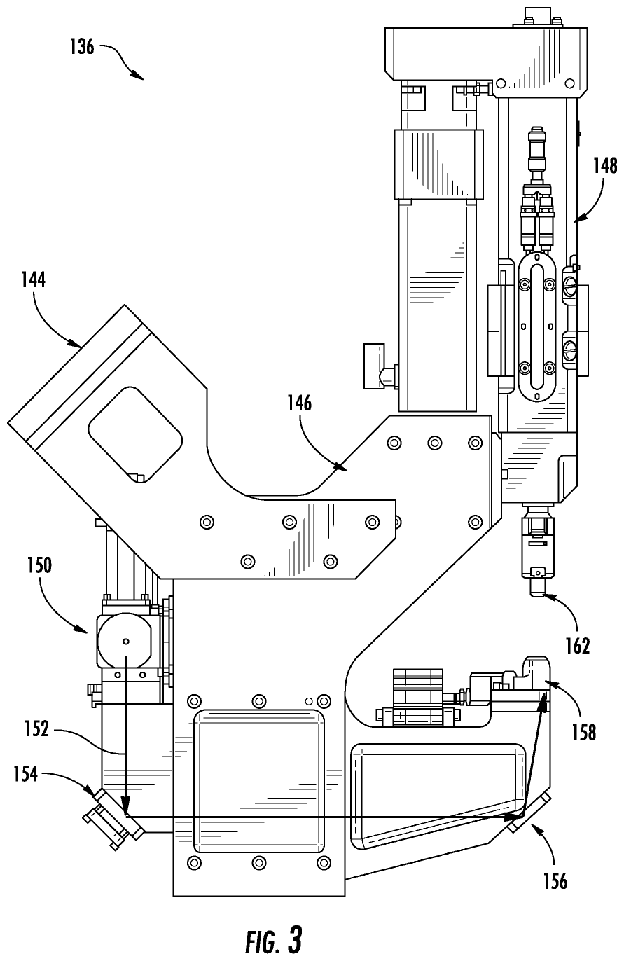

FIG. 3 illustrates the end effector 108, 110 or 136 in greater detail. According to an embodiment, the end effector 136 is a robotic laser-assisted clinch and rivet joining end of arm tool assembly 136. The end effector 136 includes mounting bracket 144 for mounting to a mounting plate at a distal end of an arm of the industrial robot 132. The bracket 144 is connected to a frame 146, which may be a weldment for supporting functional components of the end effector 136. The frame 146 may be formed in the shape of the letter ‘C’, often referred to as a C-frame, which by design contains any forces generated during the mechanical joining operation. The end effector 136 includes an actuator 148 for performing the joining operation, such as clinching, riveting, or the like. In the depicted embodiment, the actuator 148 is a servo driver motor 148. Other actuators may be employed, such as pneumatic, hydraulic, or the like. The servo actuator148 is oriented on the frame 146, spaced apart from the bracket 144 for reach and access of the stack.

A laser collimator 150 is provided on the frame 146 with focus and collimating optics for generating a coherent laser beam 152. The laser system 116 is utilized to generate the laser beam 152 to irradiate the HAZ of the stack. The laser beam 152 is precisely directed through, and enclosed safely within, the C-frame 146. The frame 146 may have a concavity, to provide a laser-safe path for the laser beam 152. A high-speed pyrometer and a fixed laser beam bender 154 are provided on the frame 146 to redirect the laser beam 152 safely through the frame 146. An adjustable laser beam bender 156 is provided on the frame 146, spaced apart from the bender 154 to redirect the laser beam 152 precisely in the HAZ of the stack that is being heated to form a mechanical joint.

The end effector 136 includes a mechanical joining tool 158 that is supported upon the frame 146 and exposed for processing the stack of material. The tool 158 is utilized to contact the stack and completely seal off the laser beam 152 onto the stack to produce an in situ optimized heat affected zone (HAZ) of the joining area. The tool 158 is spaced apart from and opposed from an output end of the actuator 148 to collectively provide the joining operation in cooperation with the actuator 148. A cooling device may be provided on an output end of the actuator 148 and/or the tool 158 to isolate the end effector 136 or the tool from excess heat during the operation. The end effector 136 provides a laser integrated joining assembly for operation with the industrial robot 132, wherein the laser beam 152 is contained so that the laser beam is classified as Class I laser safe, and no additional laser safeties are required, such as a safety booth or a safety perimeter.

Referring now to FIG. 4, the pedestal fixture 170 is a standalone fixture to receive the part/assembly being processed robotically or manually with an operator. The pedestal fixture 170 is sized to be supported upon an underlying support surface, such as a floor or other equipment, such as a press. It may also be configured to support one of the tools, such as an actuator 172 with a tool 174 as illustrated. The tool 174 is a rivet joining tool system for mechanically joining AHSS by heating with the laser, and then riveting the stack of material. The pedestal fixture 170 may be utilized in combination with one of the other tools 108, 136 for mechanical joining of AHSS. The pedestal fixture 170 supports the tool 174 at one orientation relative to an underlying support surface, or to other automation, such as a press. The pedestal fixture 170 is in electrical communication with a control panel 176, which may communicate with one of the control panels 104, 106, 134 of the prior embodiments. Alternatively, the controller 176 may be a module integrated into one of the control panels 104, 106, 134.

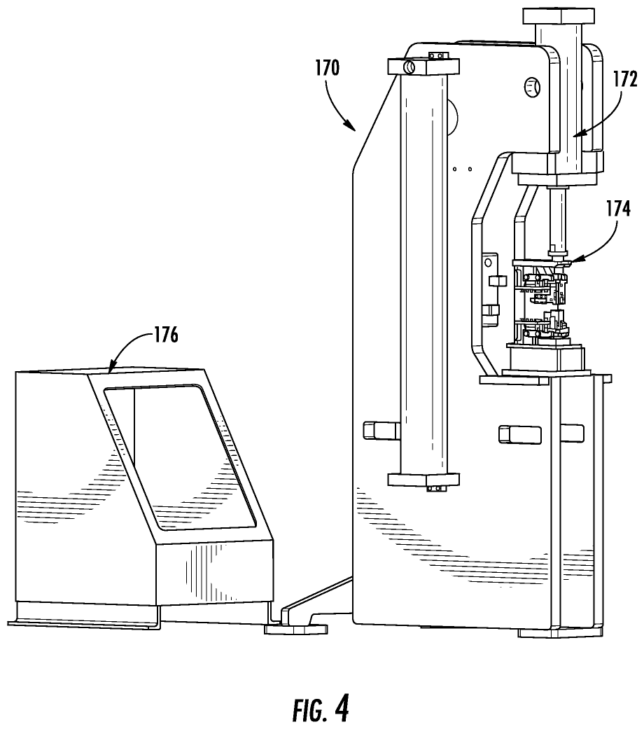

FIG. 5 illustrates a tool assembly 20 for joining AHSS, which may be provided on an end effector 108, 110, 136, 170 as the fixture 158 and the output tool assembly 162 of the previous embodiments. The tool assembly 20 includes a pair of subassemblies 22, 24, which are named in order of introduction, a first subassembly 22 and a second subassembly 24. The tool assembly 20 may be provided in a press or fixture, or on automation, such as a robot or the like, to present the pair of tool subassemblies 22, 24 to workpieces for joining the workpieces.

The first tool subassembly 22 includes a housing with an electrode 28 and a clamping surface 30. Likewise, the second tool subassembly 24 includes a housing with an electrode 34 and a clamping surface 36. The electrodes 28, 34 are oriented centrally inboard relative to the respective housings such to create an optimized HAZ.

A stack of sheet metal material is provided to be mechanically joined together. The stack of sheet metal includes at least two metal layers that are joined together by a mechanical interlock. In the depicted embodiment, the stack includes two sheets 38, 40 of a steel material that are pressed in contact with each other. Various quantities and types of material components or sheets may be provided in the stack, for various mechanical interlocks. The stack 38, 40 may be pressed in contact by automation. The two sheets 38, 40 of the stack may each be formed of AHSS. According to another embodiment, only one sheet 38, 40 of the stack is formed from AHSS, and the other sheet 38, 40 is formed from another like, or dissimilar material.

The two metal sheets 38, 40 of the stack are provided in contact for a joining operation by the tool assembly 20. Although two sheets are illustrated, additional metal sheets may be added and heated to create a mechanical joint in the HAZ 42. A controlled force is applied to the electrodes 28, 34 to provide the correct resistance on the stack 38, 40 between the clamping surfaces 30, 36 of the electrodes 28, 34. The electrodes 28, 34 are the only conductive materials to contact the sheets 38, 40 during the heating operation. A controlled current 44 is passed through the electrodes 28, 34, and consequently through the metal sheets 38, 40 to generate heat by resistance to mechanically join the sheets 38, 40 within the HAZ 42 to form a joint located within the HAZ 42 of the clamping surfaces 30, 36 at an electrode current path. The HAZ 42 is a zone throughout the layers of the stack that are affected by heat treatment in order to perform the joining operation to the stack. A mechanical joint is subsequently formed within the HAZ 42.

The clamping surfaces 30, 36 of the electrodes 28, 34 are clamped together by the actuator 148. The actuator 148 and controller 104 provide control to adjust or maintain clamping force during the heating cycle. For example, a servo driver 148 with a drive capacity of eighty kilonewtons is light enough for efficient robotic articulation while handling all applicable clamping and mechanical joining requirements. By using a controllable actuator 148, the clamping force is not limited by a spring-loaded return like a typical mechanical joining tool, such as a stripper spring to assist in retracting the tool. Various mechanical joint stacks have different clamping and joining force requirements; and the actuator 148 is controlled by the controller 64, 104 to provide the correct clamping and joining force for the associated stack of materials being process.

The second tool subassembly 24 may include a laser beam 46 in the housing. The laser beam 46 may also be utilized for heating the material sheets 38, 40. The addition of the laser beam 46 may increase the heating efficiency of the sheets 38, 40, when used in combination with the electrodes 28, 34 thereby consequently reducing a process time or alternatively to heat and improving cycle time of the thermal joining operation. The laser beam 46 may employ the teachings of Savoy et al., U.S. Pat. No. 9,815,109 B2. The laser beam 46 irradiates the first sheet 40 to heat the first and second sheets 38, 40. The second sheet 38 may be an incident or top sheet 38 accessible by the laser subassembly 136, or the first sheet 40 may be a top sheet 38, or either sheet 38, 40.

The tool assembly 20 includes at least one sensor 48 to monitor the temperature of the HAZ 42, the in situ heated region, to provide the correct joining temperature at the stack. The sensor 48 may be provided in the first tool subassembly 22 or in the second tool subassembly 24. According to another embodiment, each tool subassembly 22, 24 may be provided with a sensor 48 to monitor the temperature of the HAZ 42 at the first sheet 40 and at the second sheet 38. The sensors 48 may be infrared pyrometers or the like.

Referring now to FIG. 6, the sheets 38, 40 are illustrated schematically. Each sheet 38, 40 includes a primary layer 50, 52 of steel. The sheets 38, 40 are each coated with a protective coating layer 54, 56, 58, 60 on each exposed surface of the two sheets 38, 40. The coating layers 54, 56, 58, 60 provide protection to the steel layers 50, 52 from rust and other contaminations. The coating layers 54, 56, 58, 60, may be formed from an aluminum silicon layer (Al—Si with approximately ninety percent Aluminum and ten percent Silicon) on 22 MnB5 steel, a zinc alloy, or the like. AHSS coatings may be created during the hot forming process or another protective coating process, by an electrogalvanized coating process, by a galvannealed coating process, hot dipped, or the like.

Referring again to FIG. 5, the tool assembly 20 is provided in a metal joining and heating system 62 with a controller 64. The controller 64 is in electrical communication with the sensors 48 to receive the temperature readings and monitor the temperature of the HAZ 42. The controller 64 is also in electrical communication with the timer 142 to regulate the current through the electrodes 28, 34, and consequently to control the temperature of the HAZ 42.

The coating layers 54, 56, 58, 60 may contaminate the steel 38, 40 in the joint, which may lead to liquid metal embrittlement (LME), which may cause cracks in the joint, and may consequently result in joint failure. The coating layers 54, 56, 58, 60 may have a melting point that is less than that of steel. One method to avoid contamination of the coating layers 54, 56, 58, 60 into the joint, is by heating the HAZ 42 to an optimal temperature for the particular joining application. According to one embodiment, the HAZ 42 is heated to a temperature that is close to the melting temperature of the coating layers 54, 56, 58, 60 for protection of the coating layers 54, 56, 58, 60 at the HAZ 42. For example, the coating layers 54, 56, 58, 60 may be formed from zinc and heated to a temperature below the melting temperature of zinc, such as less than 420 degrees Celsius. The coating layers 54, 56, 58, 60 are maintained upon the stack 38, 40, to avoid corrosion of the stack 38, 40 after completing the joining operation. The intermediate coatings 56, 58 can be maintained within the joint to avoid LME. The heating and joining operations are performed with a sufficiently rapid cycle time to maintain the protection of the coatings 54, 56, 58, 60.

The HAZ 42 is heated to a temperature below the melting temperature of the steel in order to perform the thermal joining operation, such as clinching, self-piercing riveting, or any other fastening operation disclosed in Savoy et al., U.S. Pat. No. 9,815,109 B2. Alternatively, a flow screw could be installed in the joint, as disclosed in Savoy et al., U.S. patent application Ser. No. 17/121,980, filed on Dec. 15, 2020, and is incorporated in its entirety by reference herein. According to another embodiment, one of the metal sheets 38 or 40 could be attached to a clinch nut as disclosed in Savoy et al., United States Patent Application Publication Number US 2018/0250734 A1, which published to Utica Enterprises, Inc., on Sep. 6, 2018, and is incorporated in its entirety by reference herein.

The variables of clamping force, current amperage, operation time of the current, and the operation time of the laser may all be regulated together or separately in order to reach the optimized process window for the particular joining operation being performed. The sensors 48 monitor the HAZ temperature to ensure that the temperature does not cause undue damage to the material composition, or microstructure. The optimal mechanical joining temperature is below a melting temperature of the steel 38, 40. For example, the laser or current may be turned on and off during the heating operation to control the temperature or create the optimal HAZ of one or more of the sheets in the stack 38, 40.

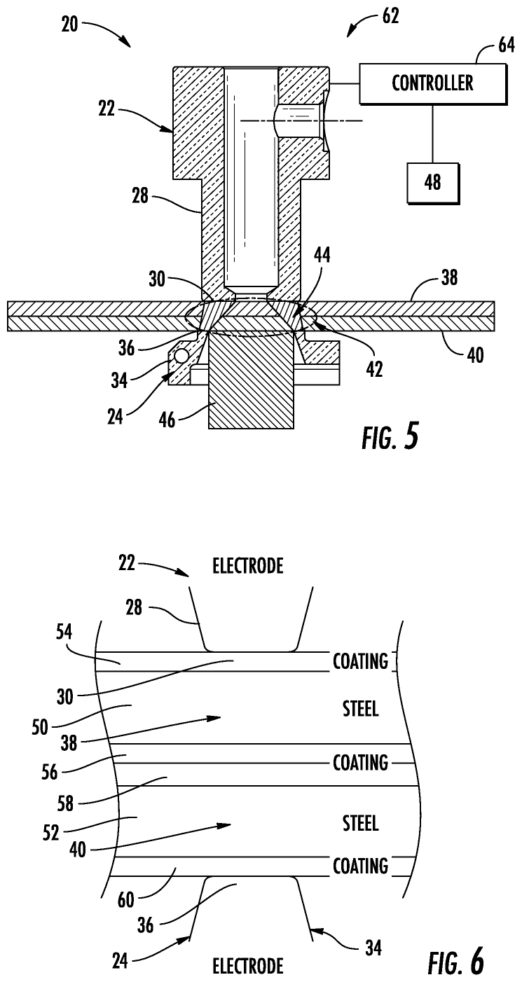

FIG. 7 illustrates a sample schematic of a resistance heating sequence according to an embodiment. In FIG. 7, force and current are graphed over time. In an initial squeeze time at zone I, the electrodes 28, 34 are clamped on the stack 38, 40, and the laser beam 46 and current through the electrodes 28, 34 are initiated. The first squeeze time may take six cycles of a second, or more to complete this stage. The laser beam 46 and/or the electrodes heat the stack 38, 40 to a temperature in thirty to seventy-five cycles, more or less, depending on the stack thickness and AHSS steel grade of material.

During a heating cycle, the clamping force required is controlled. According to one embodiment, the electrode current may be increased, pulsed, or decreased. In this example, the laser beam 46 and the electrodes 28, 34 are powered for a variable duration, and then discontinued. The electrodes 28, 34 may be pulsed if the sensor 48 indicates a temperature drop below the specified optimal HAZ temperature. Then the electrode 28, 34 current is maintained or pulsed until the sensor 48 obtains a reading that the HAZ 42 joining temperature is reached. A quantity of current pulses may be used to maintain a joining temperature that is controlled by the controller and the timer interface to control a current level and temperature for the joining operation. The clamping and heating cycle time is estimated between thirty and seventy-five cycles, which is 0.5 to 1.25 seconds.

According to another embodiment, during zone II, the current may be increased, and then maintained. The controlled heating maintains an optimal joining temperature, for materials in the HAZ 42. The temperature is controlled by the controller and the timer to vary the current level and a time of the heating operation.

The joining operation of zone III is performed within a process window temperature range. However, due to the rapid heating, and consequent cooling, the temperature may be changing during the joining operation. Therefore, the joining operation is calculated to be performed as the stack temperature is decreasing, while within the optimal joining temperature range.

During the third time range at zone III, the quench sequence occurs. A mechanical joint is formed at optimal joining temperature as determined for each specific material combination required to complete the mechanical joining operation. The operation of heating only may be about sixty cycles, or one second.

The heating cycle in zone II of FIG. 7 presents a rapid increase in temperate over a relatively short time. It is difficult to control heating metals at such elevated temperatures over such short intervals, while avoiding melting temperatures of the stack 38, 40 in the HAZ 42. Varying the current or laser in the heating zone II increases, or decreases the energy to stabilize the heating to maintain the correct temperature within an optimal mechanical joining range for a particular stack. The varying of energies creates uniform distribution of the heat without exceeding a critical temperature, such as the melting temperature, of the steel stack in the HAZ 42. By monitoring the temperature in the heating zone II, the temperature can be controlled and maintained to reach the optimal temperature without exceeding the melting temperatures of the steel in the stack. By avoiding molten steel layers 38, 40, the strength and microstructures of the steel layers 38, 40 stay within the general strength of the AHSS in the graph of FIG. 8.

In order to reduce cost of the tool assembly 20, the laser beam 46 may be omitted. In which case, the joining operation is performed by controlled current to the electrodes 28, 34 only.

FIG. 8 illustrates a graph of tensile strength and ductility for various grades of sheet steel particularly favorable in manufacturing of vehicles. The graph illustrates the developments of steels within the industry and is often referred to as a banana chart. The ductility is illustrated as an elongation percentage. Conventional steels such as interstitial-free (IF) steel, mild steel, interstitial-free high strength (IFHS) steel, bake-hardenable (BH) steel, carbon-manganese (CMn) steel, high-strength low-alloy (HSLA) steel, and ferritic-bainitic (FB) steel have tensile strengths under 1,000 MPa and ductility that ranges from sixty percent to less than ten percent.

The development of AHSS results in various tensile strength ranges that are significantly higher than conventional steels. Twinning induced plasticity (TWIP) steel is said to have a high ductility for AHSS grades at fifty to seventy percent with a tensile strength ranges up to at least 1,400 Megapascals.

Martensitic/hot-stamped (MART) steel has a low ductility at less than ten percent with tensile strengths exceeding 2,000 Megapascals. Manganese-boron hot-formed (MnB+HF) steel also has a low ductility at less than ten percent with tensile strengths that may exceed 1,800 Megapascals. Although extreme tensile strengths have been obtained for Martensitic/hot-stamped steel and Magnesium-boron hot-formed steel, the low ductility prevents common/typical mechanically joining these materials without enhancing the ductility of the material.

Dual-phase (DP) and complex phase (CP) steels provide ductility of up to thirty percent and tensile strengths up to 1,400 Megapascals. Transformation induced plasticity (TRIP) steel has a ductility percentage of less than forty percent with a maximum tensile strength less than 1,300 Megapascals.

In order to optimize ductility of AHSS for use in vehicle manufacturing, the steel industry is developing third generation AHSS with greater/enhanced ductility, which is approaching that of conventional steels. The third generation AHSS has a tensile strength up to 1,700 Megapascals and beyond. The steel industry is developing the third generation AHSS grades to improve crash energy performance and weight reduction with increased ductility to over forty percent and to tensile strengths over 2,000 Megapascals. Third generation steels are also under development to provide materials that can be conventionally stamped without hot forming during the metal stamping process.

The flexibility of the tool assembly 20 with electrode heating enables fast, efficient, and even heating through the HAZ 42 of the stack. The laser beam 46 focuses the heating energy on one surface, which takes additional time to conduct the heat homogenously through all layers of the stack. Reflective surfaces and coatings of steel sheets may also be resistant to heating by laser beams and electrodes due to the additional protective layers. Reflective surfaces and coatings of steel sheets may also be inhibitors to heating by laser beams and electrodes due to reflectivity and composition. By monitoring the temperature of the HAZ 42, the systems 100, 110, 170 can effectively and optimally heat the HAZ 42, while not melting steel in the stack 38, 40 in order to maintain the general characteristics of the microstructure of the material grades in the stack at the HAZ 42.

By maintaining the general properties of the stack at the HAZ 42, the strength of the mechanical joint is maximized. The uniformity of the strength within the joint provides a joint with the same general characteristics as the stack. For every specific grade of AHSS, and each specific combination of materials in the stack a clamp force, current and time schedule can be charted like shown in FIG. 8 in order to provide the mechanical joint integrity without exceeding the critical temperature of the steels while minimizing the joining cycle time.

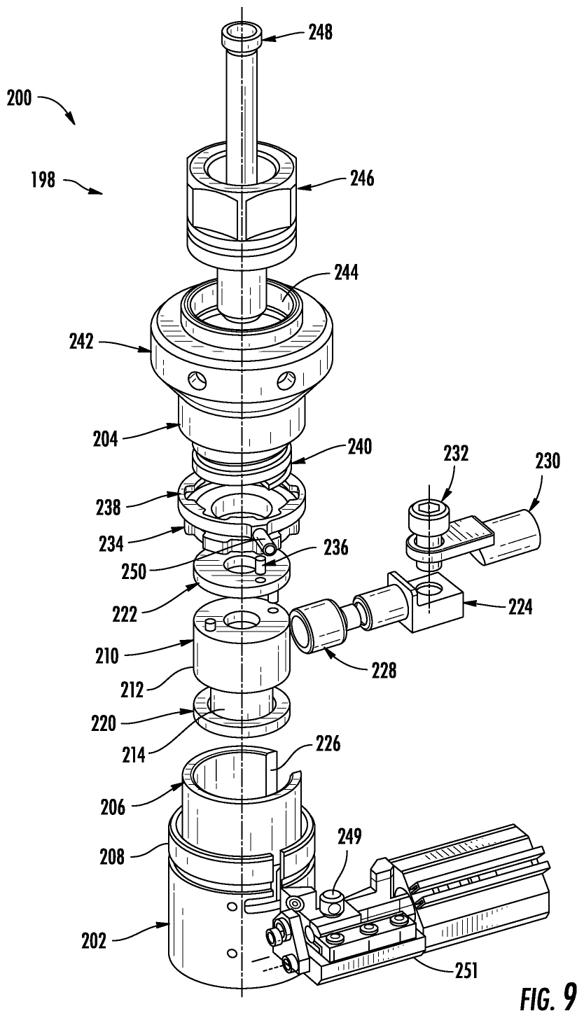

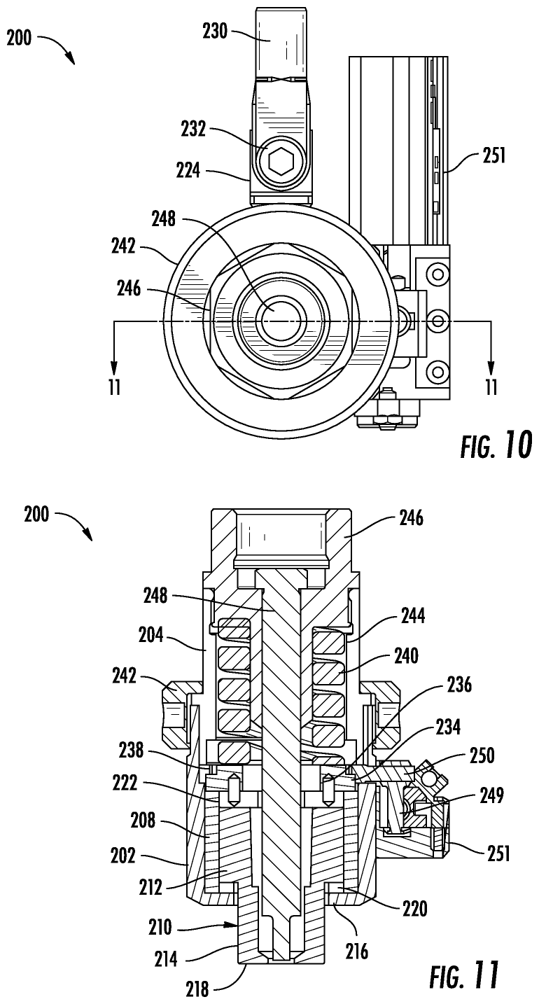

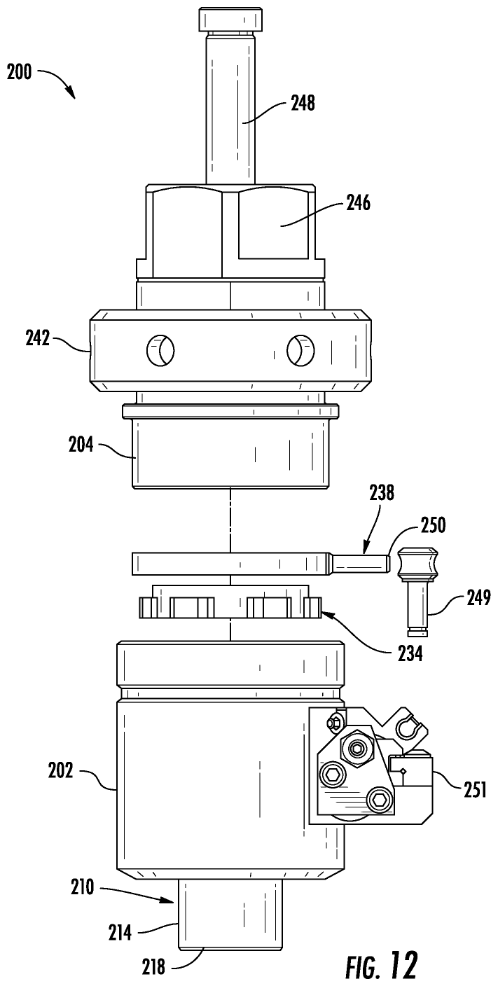

FIGS. 9-12 illustrate a tool subassembly 200 according to another embodiment. The tool subassembly 200 may be utilized on an end effector 108, 110, 136, 170 of one of the prior embodiments. The tool subassembly 200 is one subassembly of an electrode assembly 198. The electrode assembly 198 also includes a second tool subassembly. The first tool subassembly 200 and the second tool subassembly clamp the stack therebetween and convey current through the stack to heat the HAZ 42. The tool subassembly 200 is connected to the actuator 148. The tool subassembly 200 includes a first body 202 and a second body 204 to retain components of the clamp subassembly 200.

The first body 202 includes a receptacle 208 to receive an insulator bushing 206. The tool subassembly 200 includes an electrode 210. The electrode 210 includes a body 212 with an outer diameter received within the receptacle 208 of the second body 204. The electrode body 212 is insulated from the first body 202 by the insulator bushing 206. The electrode 210 includes a reduced diameter portion 214 extending out of an aperture 216 (FIG. 11) in the second body 204. A clamping surface 218 is provided on a distal end of the electrode 210. An insulator washer 220 is provided within the receptacle 208 between the first body 202 and an axial end of the electrode body 212. Another insulator washer 222 is provided on the other axial end of the electrode body 212.

A stud 224 is connected to the electrode 210 through a slot 226 in the insulator bushing 206. Another insulator bushing 228 (FIG. 9) is provided on the stud 224. A lug 230 is connected to the stud 224 with a fastener 232 to convey current through the electrode 210.

An interlock ring 234 is stacked axially upon the insulator washer 222 and connected to the insulator washer with a plurality of pins 236. A stop ring 238 is stacked axially upon the interlock ring 234. A spring 240 is stacked axially upon the interlock ring 234 and extends into a cavity 244 in the second body 204. A nut 242 is provided about the second body 204 to fasten the second body 204 to the first body 202. A punch holder 246 caps a distal end of the second body 204. A punch 248 extends through the punch holder 246 to extend through the electrode 210.

The first and second bodies 202, 204 collectively retain the insulator bushing 206, the electrode 210, the insulator washers 220, 222, the interlock ring 234, the stop ring 238, the spring 240, and the punch 248. The interlock ring 234 and the stop ring 238 cooperate to bypass the spring 240 during the clamping operation to isolate the spring 240 from the clamping force and the current. Upon completion of heating with the electrode 210, the rings 234, 238 are shifted to permit the driver 148 to drive the punch 248 to compress the spring 240, and perform a joining operation, such as clinching. Then, the spring 240 returns the punch 248.

Referring now to FIGS. 9-12, a shift lever 250 extends radially outward from the stop ring 238. A coupler 249 is connected to the shift lever 250. The coupler 249 is shifted by an actuator 251. The actuator 251 may be a linear actuator. The coupler 249 cooperates with the actuator 251 to pivot during translation, as the shift lever 250 rotates about the stop ring 238. The coupler 249 also cooperates with the shift lever 250 to translate along the shift lever 250 as the coupler 249 is shifted.

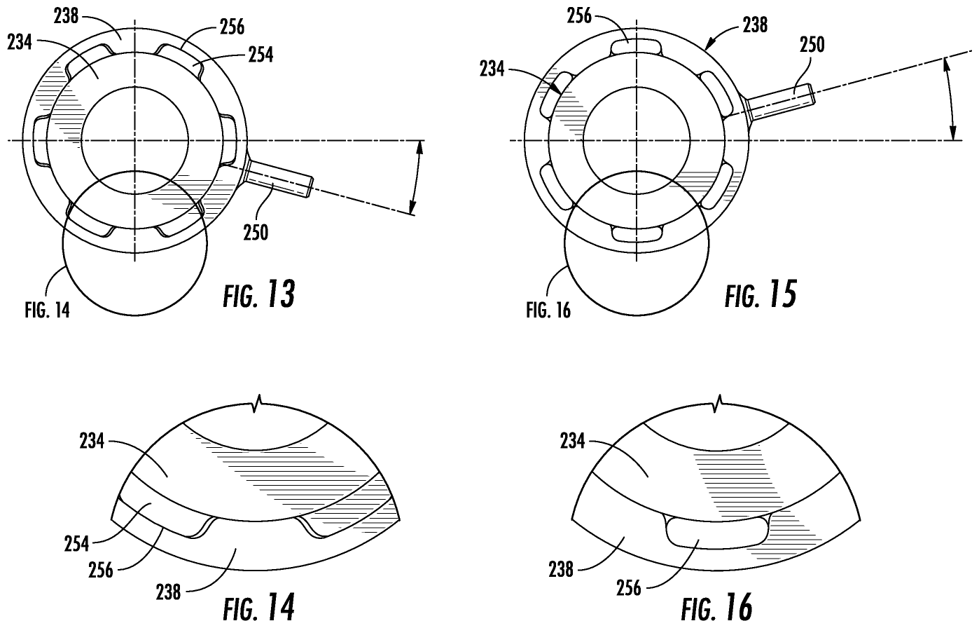

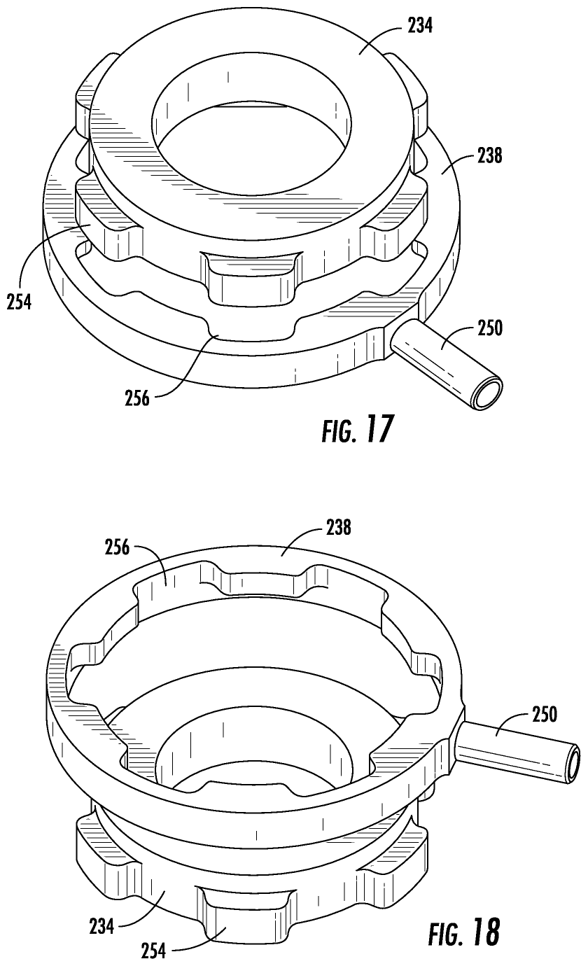

The actuation and shifting of the coupler 249 and the shift lever 250 by the actuator 251, rotates the stop ring 238 to an unlocked position (FIGS. 13, 14 and 17) and a locked position (FIGS. 15, 16 and 18). Referring now to FIGS. 13-18, the interlocking ring 234 includes a radial array of outward lugs 254. The stop ring 238 includes a corresponding array of inward radial slots 256. Each of the slots 256 provides clearance for one of the lugs 254. In the unlocked condition of FIGS. 13, 14 and 17, the slots 256 of the stop ring 238 are aligned with the lugs 254, thereby permitting axial translation of the interlocking ring 234 relative to the stop ring 238. The axial translation of the of the interlocking ring 234 permits the driver 148 to drive the punch 248 and compress the spring 240. Likewise, the axial translation of the interlocking ring 234, permits the spring 240 to expand, thereby assisting retraction of the punch 248.

When the stop ring 238 is shifted to rotate out of phase with the interlocking ring 234, the punch 248 of the clamping subassembly 200 is locked. In the locked condition illustrated in FIGS. 15, 16 and 18, the slots 256 of the stop ring 238 are not aligned with the lugs 254 of the interlocking ring 234. In this position, the stop ring 238 blocks the lugs 254 and consequently prevents linear translation of the interlocking ring 234.

During the heating operation, the actuator or drive 148 provides the clamping operation force to ensure sufficient contact at the clamping surfaces 30, 36 for electrode heating. The heat is discontinued, and the actuator 148 releases clamp force to permit unlocking of the stop ring 238. Next the stop ring 238 is shifted to the unlocked position. Next the driver 148 actuates the punch 248 to perform the mechanical joining operation. Then the stop ring 238 is shifted to the lock position for the next clamping and heating operation.

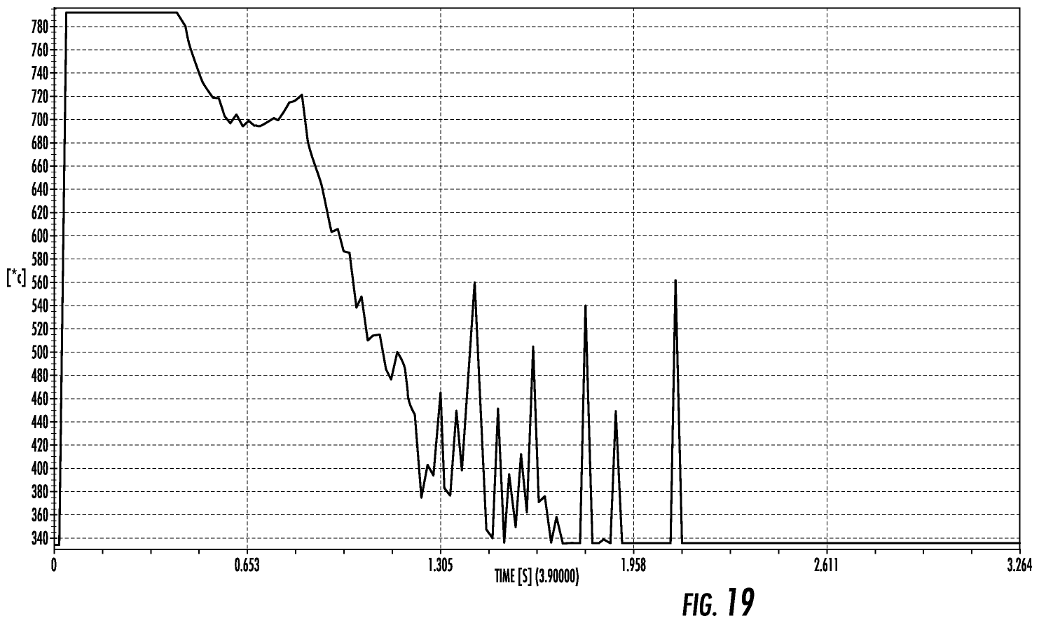

FIG. 19 illustrates a graph of a heating operation of heat over time of a sheet of AHSS and a sheet of aluminum with the electrodes of the prior embodiments. The required mechanical joining temperature at approximately 720 degrees Celsius on sheet 40 is reached in eighty-seven milliseconds while the upper aluminum sheet 38 in this case does not exceed 300 degrees Celsius.

FIG. 20 is a graph of a heating operation of press hardened steel to press hardened steal with the electrodes of the prior embodiments. A temperature exceeding 780 degrees Celsius is reached in approximately 0.5 seconds and is held for 1.25 seconds. Under this heating operation, a total joining cycle time of approximately two seconds is obtained.

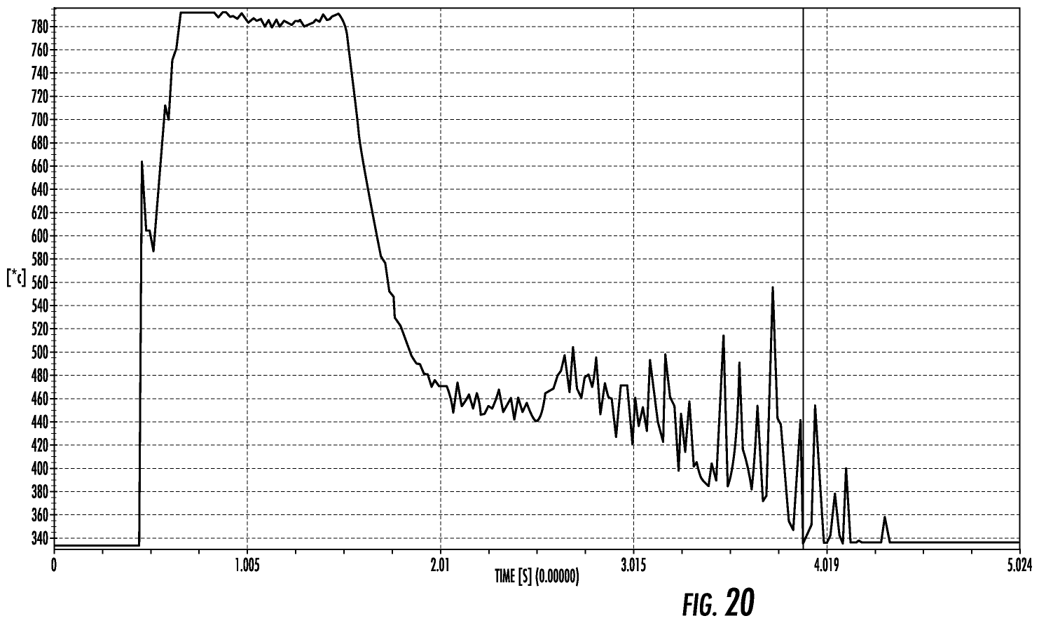

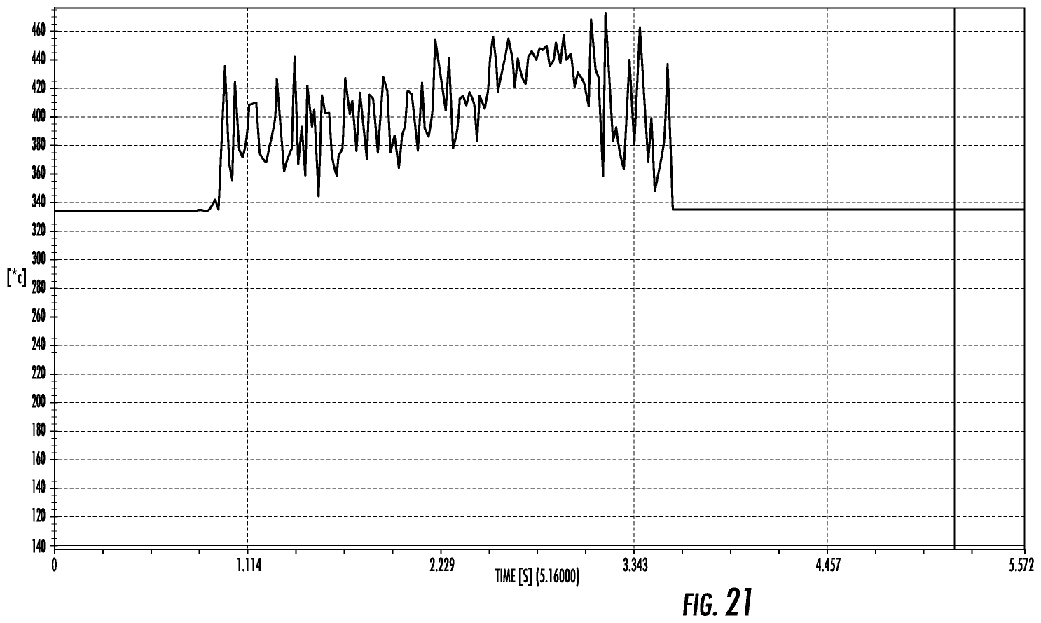

FIG. 21 is a graph of a heating operation of a hot-dipped zinc-coated third generation AHSS for installation of a mechanical joint. The stack is heated to an average range of 380 degrees Celsius, and the temperature is maintained within the range for over two seconds, while the temperature is maintained above 380 degrees Celsius over four seconds.

FIGS. 22-25 illustrate an alternative tool assembly 260 according to another embodiment. The tool assembly 260 includes a base 262, which may be a substrate 262, a baseplate 262 or an adaptor plate 262 for articulation and manipulation by the automation equipment. For example, the plate 262 may be mounted to, and driven by, the actuator 148, which may in turn, be articulated by the industrial robot 102, 132.

The baseplate 262 supports a retraction assembly 264 with a plurality of guide shafts 266 and a plurality of dampers 268. The guide shafts 266 are axially translatable relative to the baseplate 262. The dampers 268 may be fluid dampers 268, such as gas springs. A drive plate 270 is connected to the retraction assembly 264. An electrode 272 is mounted to, and isolated from, the drive plate 270 to be spaced apart from the retraction assembly 264. A punch 274 is illustrated in FIGS. 23-25 in connection to the baseplate 262 and extending through a central bore 276 in the electrode 272. The punch 274 may be a clinch punch, a rivet ram, or the like, for performing a mechanical joining operation through the electrode 272.

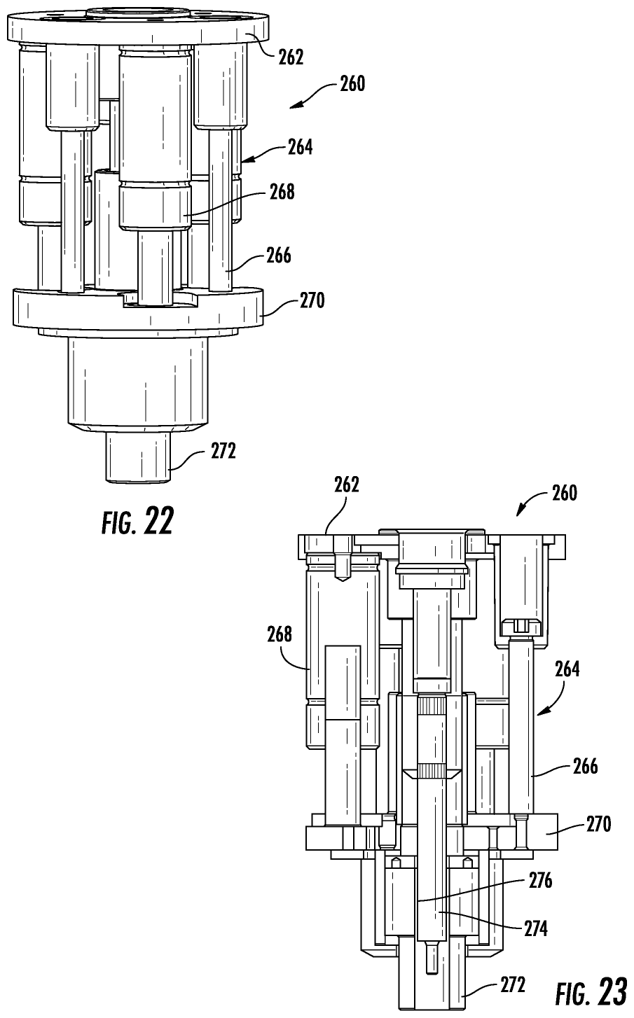

During operation of the tool assembly 260, the actuator 148 drives the baseplate 262 such that the electrode 272 engages the stack. As the baseplate 262 is further driven from FIG. 23 and FIG. 24, the clamping force is applied, thereby loading, and compressing the retraction assembly 264. Further actuation of the baseplate 262, illustrated in FIG. 25, further compresses the retraction assembly 264 thereby driving the punch 274 through the electrode 272 and into engagement with a fastener or the stack.

The tool assembly 260 permits uninterrupted actuation for clamping and then forming a mechanical joint. The tool assembly 260 permits the driver 148 to clamp the electrode 272 while heating, and then drive the punch 274 in the same linear motion, without retracting between clamping and forming. The continuous drive operation reduces cycle time and increases tooling life cycle by performing both functions without interrupting the motion or the output of the driver 148.

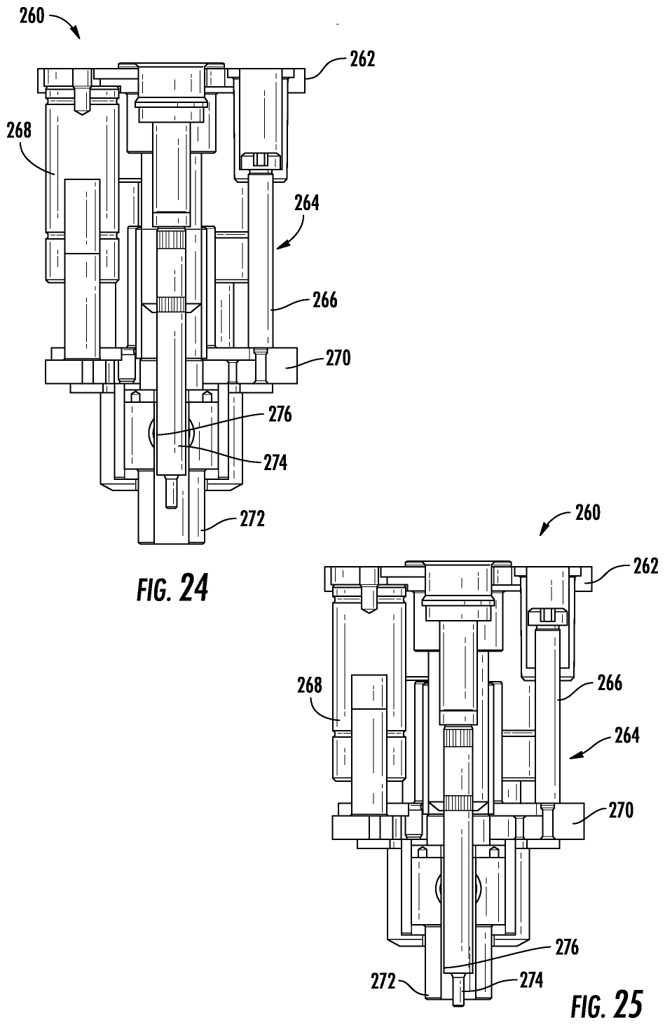

As illustrated in the progression of FIGS. 26 and 27, a clinch punch 300 and a clinch die 302 of each embodiment cooperate with each other to provide a clinch joint 304 as shown in FIG. 28 for joining first and second sheet portions of steel pieces 306 and 308 to each other.

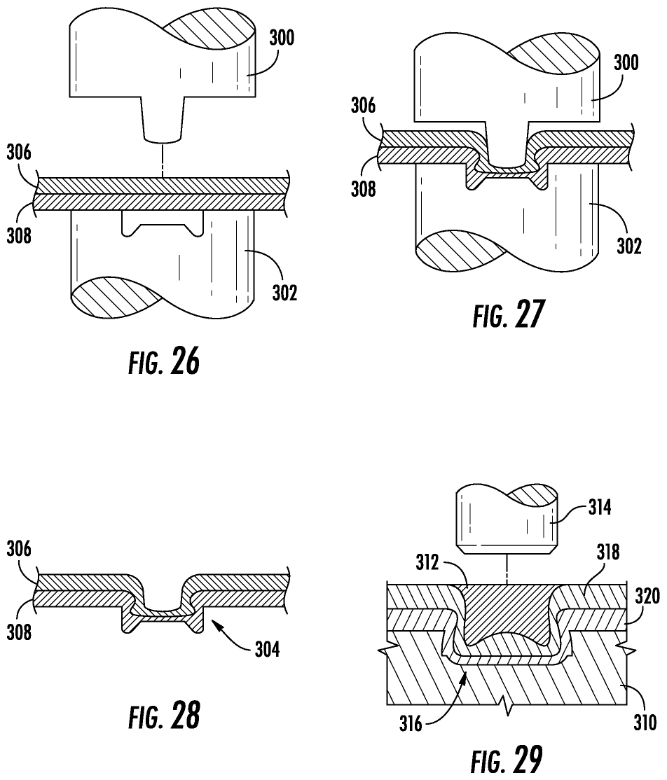

With reference to FIG. 29, a clinch-rivet die 310 and a clinch rivet 312 under the operation of rivet ram 314 provide a clinch-rivet joint 316 of an AHSS piece 318 and metal piece 320 to each other.

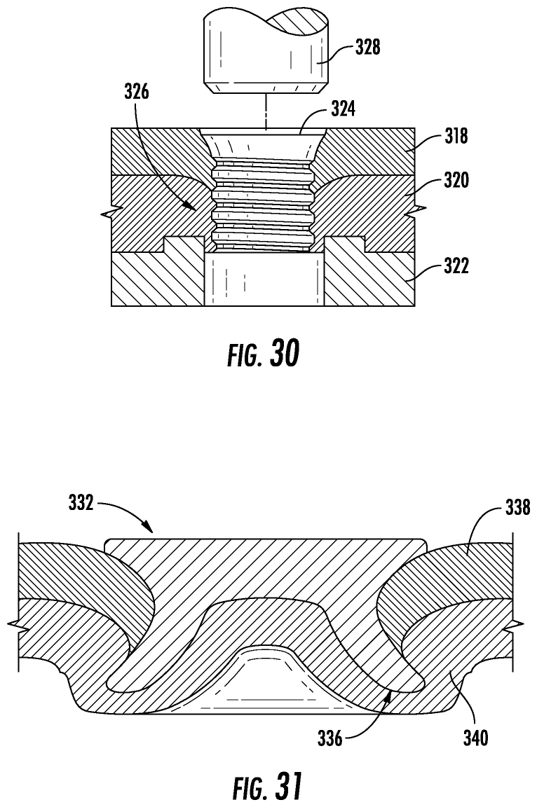

With reference to FIG. 30, a full-punch rivet die 322 and a full-piercing rivet 324 provide a full-punch rivet operation that provides a full-punch rivet joint 326. In this embodiment, a punched-out piece drops below the die 322 by driving of the rivet 324 with a rivet ram 328.

With reference to FIG. 31, a self-piercing rivet 332 is illustrated after driven by a rivet ram to provide a self-piercing rivet joint 336 between sheet portions 338, 340. The sheet portions 338, 340 may have been supported by a die (not shown) during the forming process.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for mechanically joining steel comprising:
applying a variable clamp force to a stack of sheet metal portions, which include at least one portion of advanced high strength steel (AHSS); and
heating the stack to an optimal mechanical joining temperature to preserve strength and material properties of the stack and to form a mechanical joint with the AHSS.

2. The method of claim 1 further comprising heating the stack to a temperature below a melting temperature of the stack.

3. The method of claim 2 further comprising heating a heat affected zone (HAZ) portion of a joining area of the stack.

4. The method of claim 3 further comprising controlling and monitoring a temperature of the HAZ portion of the stack during the heating.

5. The method of claim 1 further comprising heating the stack with a laser assembly.

6. The method of claim 1 further comprising heating the stack with a pair of electrodes.

7. The method of claim 6 further comprising applying the variable clamp force with the pair of electrodes.

8. The method of claim 1 further comprising actuating an actuator to form the mechanical joint.

9. The method of claim 8 further comprising actuating the actuator to apply the variable clamp force and to form the mechanical joint with the same actuation.

10. A mechanical joint formed by the method of claim 1.

11. A method for mechanically joining steel comprising:
clamping a stack of sheet metal portions, which include at least one portion of advanced high strength steel (AHSS); and
heating the stack to a temperature below a melting temperature of the stack to mechanically join the stack together.

12. The method of claim 11 further comprising heating a heat affected zone (HAZ) portion of a joining area of the stack.

13. The method of claim 12 further comprising controlling and monitoring a temperature of the HAZ portion of the stack during the heating.

14. The method of claim 11 further comprising heating the stack with a laser assembly.

15. The method of claim 11 further comprising heating the stack with a pair of electrodes.

16. The method of claim 15 further comprising applying a variable clamp force with the pair of electrodes.

17. The method of claim 11 further comprising actuating an actuator to form the mechanical joint.

18. The method of claim 17 further comprising actuating the actuator to apply a variable clamp force and to form the mechanical joint with the same actuation.

19. A tool assembly comprising:
a pair of clamping surfaces to clamp a stack of sheet metal portions, which include at least one portion of advanced high strength steel; and
a pair of electrodes providing the pair of clamping surfaces to apply current through the stack to heat the stack so that a mechanical joint is formed to join the stack together.

20. The tool assembly of claim 19 wherein the tool assembly is further defined as an end effector adapted to be mounted to automation.

21. The tool assembly of claim 19 further comprising an actuator to perform a mechanical joining operation to form the mechanical joint.

22. The tool assembly of claim 21 wherein the actuator actuates the pair of clamping surfaces to clamp the stack of sheet metal portions.

23. A system comprising:
a tool assembly to clamp a stack of sheet metal portions, which include at least one portion of advanced high strength steel;
an electrode arrangement to heat the stack to a predetermined temperature to provide an optimal ductility in the stack to form a mechanical joint; and
a controller in electrical communication with the tool assembly to monitor joining temperatures of a heat affected zone of the stack.

24. The system of claim 23 wherein the tool assembly further comprises a laser assembly to heat the stack to an optimal temperature to form the mechanical joint.

25. An assembly comprising:
at least one portion of advanced high strength steel with a protective coating; and
a metallic component mechanically joined with at least one portion of advanced high strength steel with the protective coating between the at least one portion and the metallic component within the mechanical joint.
